(19) United States
(12) Patent Application Publication
(10) Pub. No.: US 2026/0120049 A1
(43) Pub. Date: Apr. 30, 2026

(54) BATCH MATCHING BY SYNCHRONIZATION OF BROADCAST SIGNAL AND BOOST SIGNAL

(71) Applicant: Maplebear Inc., San Francisco, CA (US)

(72) Inventors: Rahul Makhijani, Daly City, CA (US); Shang Li, Jersey City, NJ (US); Bing Hong Leonard How, South San Francisco, CA (US); Reza Faturechi, San Francisco, CA (US); Wenhui Zhang, Redwood City, CA (US); Yixiang Zeng, Fremont, CA (US)

(21) Appl. No.: 18/931,672

(22) Filed: Oct. 30, 2024

(51) Int. Cl. G06Q 10/087; G06Q 30/02

(52) U.S. Cl. CPC G06Q 10/087; G06Q 30/02

(57) ABSTRACT

An online system performs batch matching with synchronization between a broadcast signal and a boost signal. At a first timestep, the system notifies a first set of candidate pickers of a batch. If no picker selects the batch, the system identifies a catalyst action to facilitate matching. The system applies a decision model to determine whether to increase a broadcast signal or to increase a boost signal. If increasing the broadcast signal, the system identifies additional candidate pickers to notify of the batch. If increasing the boost signal, the system transmits the boost signal to the pickers for notification. The system may iteratively assess whether a candidate picker has selected the batch. If not, then the system may identify and perform additional catalyst actions to facilitate the matching of the batch. Eventually, the system receives a selection by one of the candidate picking users for fulfillment.

### BACKGROUND

Optimizing order fulfillment is a critical problem. At any given time, any number of orders could be received by requesting users with any number of picking users presently available for accepting such orders to fulfill. Given the disparate dispersion of orders to be fulfilled at various in-store locations and the dispersion of candidate picking users, the task of notifying picking users of new batches of orders is a complex problem. One tool or lever to aid in the matching process is staged broadcast of the new batch. Broadly broadcasting a batch, despite potentially resulting in a quick acceptance of a batch by a picking user, could inadvertently result in a prolonged fulfillment process (e.g., if the picking user is physically located further from the fulfillment locations associated with the batch, or the like), which could lead to extended lag times due to the picker's longer route to the fulfillment locations, increased fuel expenditure, or other systemic inefficiencies. Another tool or lever to aid in the matching process is boosting the batch by allocating system resources to the batch. This resource allocation can also expedite the speed of acceptance by picking users, but it could also unnecessarily deplete the system's resources. In other systems, these two levers work independently, creating friction between the two levers competing to achieve the same objective. Thus, there's the added challenge in trying to synchronize or coordinate use of these two levers to minimize the friction.

### SUMMARY

An online system performs batch matching by synchronizing a broadcast signal and boost signal when notifying pickers of an available batch of orders to be fulfilled at one or more fulfillment locations. At a first timestep, the system notifies a first set of candidate pickers of a batch. If no picker selects the batch, the system identifies a catalyst action to facilitate matching. The system applies a decision model to determine whether to increase a broadcast signal or to increase a boost signal. If increasing the broadcast signal, the system identifies additional candidate pickers to notify of the batch. If increasing the boost signal, the system transmits the boost signal to the pickers for notification. The system may iteratively assess whether a candidate picker has selected the batch. If not, then the system may identify and perform additional catalyst actions to facilitate the matching of the batch. Eventually, the system receives a selection by one of the candidate picking users for fulfillment.

Synchronization of the two levers, the broadcast signal and the boost signal, with a central decision-maker (i.e., the decision model) yields a technical solution to the above-noted downsides to independent toggling of the two levers. Accordingly, synchronization can yield aid in minimizing order completion lag time, saving on fuel expenditure, saving on system resources, among other benefits.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 is an illustrative flowchart describing batch matching by synchronization of broadcast and boosting, in accordance with one or more embodiments.

FIG. 4 is a method flowchart describing the process of batch matching by synchronization of broadcast and boosting, in accordance with one or more embodiments.

### DETAILED DESCRIPTION

### Online System Environment

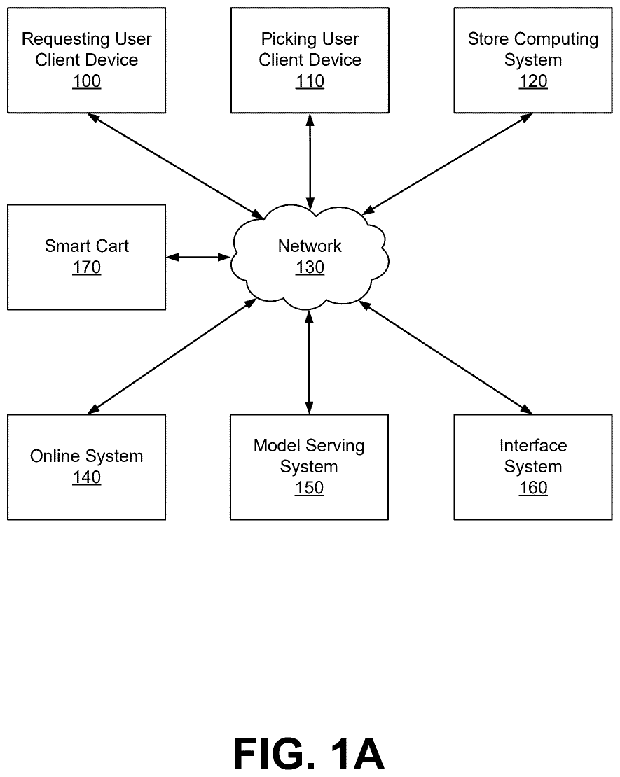

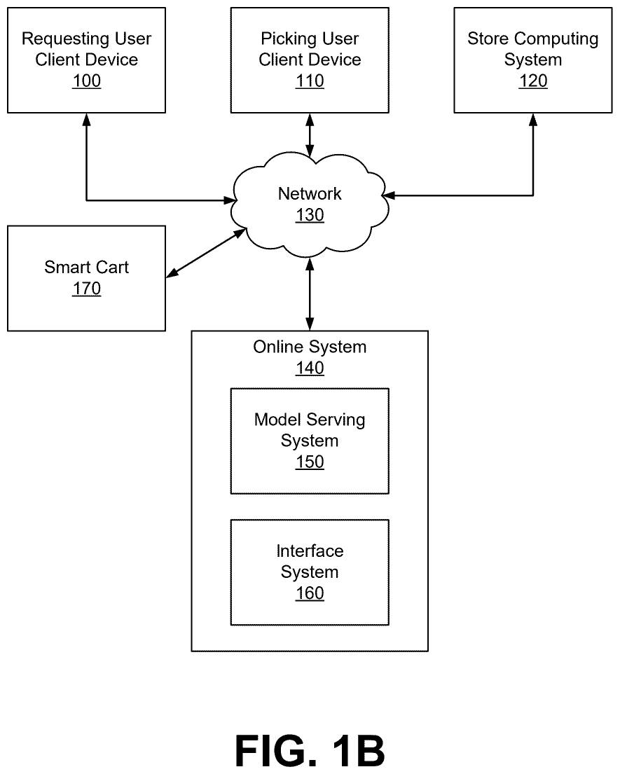

FIG. 1A illustrates an example system environment for an online system 140, in accordance with one or more embodiments. The system environment illustrated in FIG. 1A includes a requesting user client device 100, a picking user client device 110, a store computing system 120, a network 130, an online system 140, a model serving system 150, an interface system 160, and a smart cart 170. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, requesting users, picking users, and stores may be generically referred to as “users” of the online system 140. Additionally, while one requesting user client device 100, one picking user client device 110, one store computing system 120, one smart cart 170 are illustrated in FIG. 1, any number of client devices, stores, or smart carts may interact with the online system 140. As such, there may be more than one requesting user client device 100, more than one picking user client device 110, more than one store computing system 120, or more than one smart cart 170.

The requesting user client device 100 is a client device through which a requesting user may interact with the picking user client device 110, the store computing system 120, or the online system 140. The requesting user client device 100 can be a personal or mobile computing device, such as a smartphone, a tablet, a laptop computer, or desktop computer. In some embodiments, the requesting user client device 100 executes a client application that uses an application programming interface (API) to communicate with the online system 140.

A requesting user uses the requesting user client device 100 to place an order with the online system 140. A requesting user may also be referred to as a requesting user that provides orders to the online system 140 for completion. An order specifies a set of items to be delivered to the requesting user. An “item,” as used herein, means a good, a product, or a service that can be provided to the requesting user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more store locations from which the ordered items should be collected.

The requesting user client device 100 presents an ordering interface to the requesting user. The ordering interface is a user interface that the requesting user can use to place an order with the online system 140. The ordering interface may be a part of a client application operating on the requesting user client device 100. The ordering interface is a graphical user interface. The ordering interface allows the requesting user to search for items that are available through the online system 140. To perform a search, the requesting user provides a query (e.g., a text query, an audio query, or a visual query) to the online system 140. The online system 140 processes the query to return query results to the requesting user. The ordering interface graphically presents items corresponding to the query results, e.g., by obtaining characteristics of the items from a database and graphically rendering the characteristics in the interface. Based on the displayed results, the requesting user can select which items to add to an “item list.” An “item list,” as used herein, is a tentative set of items that the user has selected for an order but that has not yet been finalized for an order. The ordering interface allows a requesting user to update the item list, e.g., by changing the quantity of items, adding or removing items, or adding instructions for items that specify how the item should be collected. The user interface may also include options to provide input for user preferences. For example, the requesting user may, via the user interface, provide input tagging one or more items as favorite items. In another example, the requesting user may, via the user interface, provide input (e.g., in the form of user feedback or user messages) to past orders. The ordering interface may track user engagement with items presented in the interface. In some embodiments, the ordering interface tracks impressions of an item in the ordering interface, clicking on the item to view further details, adding the item to an item list, submitting an order with item, favoriting the item, etc.

The requesting user client device 100 may receive additional content from the online system 140 to present to a requesting user. For example, the requesting user client device 100 may receive coupons, recipes, or item suggestions. The requesting user client device 100 may present the received additional content to the requesting user as the requesting user uses the requesting user client device 100 to place an order (e.g., as part of the ordering interface).

Additionally, the requesting user client device 100 includes a communication interface that allows the requesting user to communicate with a picking user that is servicing the requesting user's order. This communication interface allows the user to input a text-based message to transmit to the picking user client device 110 via the network 130. The picking user client device 110 receives the message from the requesting user client device 100 and presents the message to the picking user. The picking user client device 110 also includes a communication interface that allows the picking user to communicate with the requesting user. The picking user client device 110 transmits a message provided by the picking user to the requesting user client device 100 via the network 130. In some embodiments, messages sent between the requesting user client device 100 and the picking user client device 110 are transmitted through the online system 140. In addition to text messages, the communication interfaces of the requesting user client device 100 and the picking user client device 110 may allow the requesting user and the picking user to communicate through audio or video communications, such as a phone call, a voice-over-IP call, or a video call.

The picking user client device 110 is a client device through which a picking user may interact with the requesting user client device 100, the store computing system 120, or the online system 140. The picking user client device 110 can be a personal or mobile computing device, such as a smartphone, a tablet, a laptop computer, or desktop computer. In some embodiments, the picking user client device 110 executes a client application that uses an application programming interface (API) to communicate with the online system 140.

The picking user client device 110 selects orders for completion. The online system 140 may present active and unselected orders submitted by requesting users. The picking user, via the picking user client device 110, may select one or more of the orders for completion. Upon selection of one or more orders (and approval of the match by the online system 140), the picking user client device 110 receives the orders from the online system 140 for the picking user to fulfill. Items in the order may be presented in a particular sequence (i.e., display order) to optimize efficiency of the picking user. A picking user completes an order by collecting the items listed in the order from a store.

The picking user client device 110 presents the items that are included in the requesting user's order to the picking user in a collection interface. The collection interface is a user interface that provides information to the picking user on which items to collect for a requesting user's order and the quantities of the items. In some embodiments, the collection interface provides multiple orders from multiple requesting users for the picking user to service at the same time from the same store location. The collection interface further presents instructions that the requesting user may have included related to the collection of items in the order. Additionally, the collection interface may present a location of each item at the store, and may even specify a sequence in which the picking user should collect the items for improved efficiency in collecting items. In some embodiments, the picking user client device 110 transmits to the online system 140 or the requesting user client device 100 which items the picking user has collected in real time as the picking user collects the items.

The picking user can use the picking user client device 110 to keep track of the items that the picking user has collected to ensure that the picking user collects all of the items for an order. The picking user client device 110 may include a barcode scanner that can determine an item identifier encoded in a barcode coupled to an item. The picking user client device 110 compares this item identifier to items in the order that the picking user is servicing, and if the item identifier corresponds to an item in the order, the picking user client device 110 identifies the item as collected. In some embodiments, rather than or in addition to using a barcode scanner, the picking user client device 110 captures one or more images of the item and determines the item identifier for the item based on the images. The picking user client device 110 may determine the item identifier directly or by transmitting the images to the online system 140. Furthermore, the picking user client device 110 determines a weight for items that are priced by weight. The picking user client device 110 may prompt the picking user to manually input the weight of an item or may communicate with a weighing system in the store location to receive the weight of an item.

When the picking user has collected all of the items for an order, the picking user client device 110 instructs a picking user on where to deliver the items for a requesting user's order. For example, the picking user client device 110 displays a delivery location from the order to the picking user. The picking user client device 110 also provides navigation instructions for the picking user to travel from the store location to the delivery location. When a picking user is servicing more than one order, the picking user client device 110 identifies which items should be delivered to which delivery location. The picking user client device 110 may provide navigation instructions from the store location to each of the delivery locations. The picking user client device 110 may receive one or more delivery locations from the online system 140 and may provide the delivery locations to the picking user so that the picking user can deliver the corresponding one or more orders to those locations. The picking user client device 110 may also provide navigation instructions for the picking user from the store location from which the picking user collected the items to the one or more delivery locations.

In some embodiments, the picking user client device 110 tracks the location of the picking user as the picking user delivers orders to delivery locations. The picking user client device 110 collects location data and transmits the location data to the online system 140. The online system 140 may transmit the location data to the requesting user client device 100 for display to the requesting user, so that the requesting user can keep track of when their order will be delivered. Additionally, the online system 140 may generate updated navigation instructions for the picking user based on the picking user's location. For example, if the picking user takes a wrong turn while traveling to a delivery location, the online system 140 determines the picking user's updated location based on location data from the picking user client device 110 and generates updated navigation instructions for the picking user based on the updated location.

The picking user client device 110 may also provide a communication interface to the picking user, e.g., to communicate with another user of the online system 140. For example, the communication interface of the picking user client device 110 may present messages from a requesting user client device 100 to the picking user client device 110. Such communication may be utilized when items in an order are unavailable at the store location. In such scenarios, the picking user may query the requesting user for suitable substitution items to be obtained for the unavailable item. The messages may be in the form of text, audio, pictures, other digital manners of communicating information, etc.

In one or more embodiments, the picking user is a single person who collects items for an order from a store location and delivers the order to the delivery location for the order. Alternatively, more than one person may serve the role as a picking user for an order. For example, multiple people may collect the items at the store location for a single order. Similarly, the person who delivers an order to its delivery location may be different from the person or people who collected the items from the store location. In these embodiments, each person may have a picking user client device 110 that they can use to interact with the online system 140.

The store computing system 120 is a computing system operated by a store that interacts with the online system 140. As used herein, a “store” is an entity that operates a “store location,” which is a store, warehouse, or other building from which a picking user can collect items. The store computing system 120 stores and provides item data to the online system 140 and may regularly update the online system 140 with updated item data. For example, the store computing system 120 provides item data indicating which items are available at a particular store location and the quantities of those items. Additionally, the store computing system 120 may transmit updated item data to the online system 140 when an item is no longer available at the store location. Additionally, the store computing system 120 may provide the online system 140 with updated item prices, sales, or availabilities. Additionally, the store computing system 120 may receive payment information from the online system 140 for orders serviced by the online system 140. Alternatively, the store computing system 120 may provide payment to the online system 140 for some portion of the overall cost of a user's order (e.g., as a commission).

The store computing system 120 may provide the online system 140 with store data describing the store associated with the store computing system 120. The store data may include store name, store address, store website, store phone number, other identifying information, a type of store, an expense class of the store (e.g., $, $$, or $$$), opening hours, general dependability of items, diversity of items, types of items carried, or information describing the store, or some combination thereof. The online system 140 may further infer additional store data based on interactions between requesting users or picking users and the store. For example, such store data based on the interactions may include requesting user reviews, picking user reviews, popular items ordered, dependability of items, etc.

In one or more embodiments, the store computing system 120 may include a cart tracking system for tracking locations of smart carts throughout the in-store environment. In one or more embodiments, the cart tracking system may implement sensors positioned around the in-store environment and/or sensors coupled to the smart carts. In embodiments with sensors positioned around the in-store environment, the sensors may wirelessly communicate with counterpart devices on the smart carts to determine a location of each smart cart. In embodiments with sensors coupled to the smart carts, the sensors may wirelessly communicate with counterpart devices positioned around the in-store environment to determine a location of each smart cart. For example, the sensors may communicate with radiofrequency identifier (RFID) tags to triangulate a position of the sensors and/or the RFID tags. In one example, each smart cart includes a RFID reader as the sensor which receives signals from RFID tags positioned around the in-store environment. Based on the received signals, the tracking system can triangulate a position of the smart cart. In another example, each smart cart includes an RFID tag and RFID readers positioned around the in-store environment can read the signal from the cart's RFID tag to triangulate a position of the smart cart. In other embodiments, each smart cart may include additional components to aid in locating the smart cart in the in-store environment, including: wheel sensors, accelerometers, inertial measurement units, magnetometers, imaging devices, inclinometers, etc.

The requesting user client device 100, the picking user client device 110, the store computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, x4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

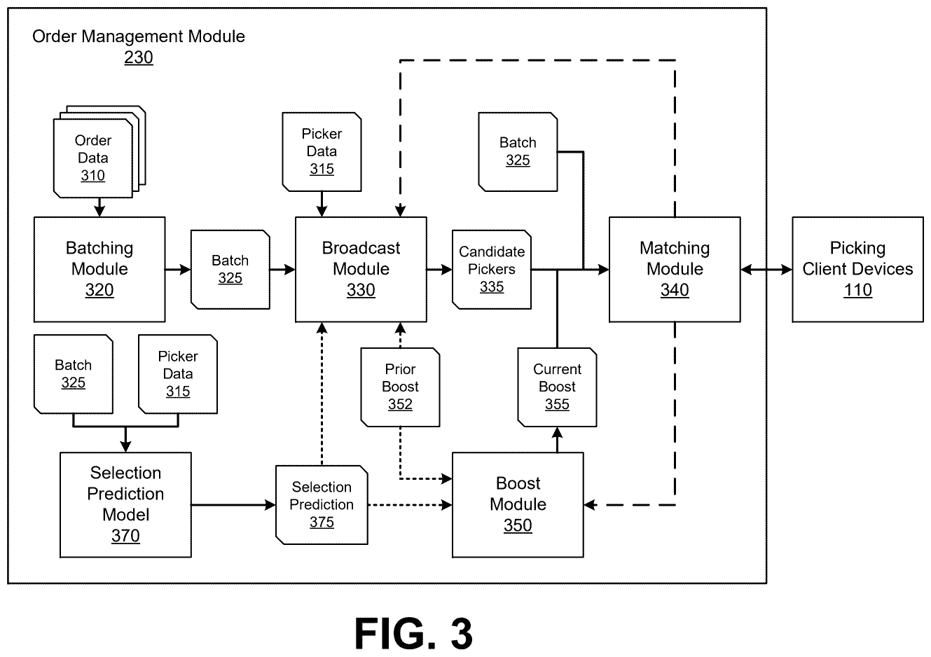

The online system 140 is an online system by which requesting users can order items to be provided to them by a picking user from a store. The online system 140 receives orders from one or more requesting user client devices 100 through the network 130. The online system 140 transmits orders (or batches of orders) to one or more picking users for selection. In facilitating matching of orders with picking users, the online system 140 may control the breadth of broadcast of a given batch to picking users and may control boosting of the batch to incentivize selection by picking users. The online system 140 may implement a matching module to identify actions to take at different timesteps. For example, the matching module may identify when to increase broadcast, when to increase boost of a batch, or when to hold. By coordinating the actions available to the online system 140, the matching module can minimize unnecessary expenditure of system resources while balancing order fulfillment efficiency. Additional details relating to the matching module are described below in FIGS. 3 & 4. Upon receiving selection or acceptance by a picking user client device 110 (and, in some embodiments, pending approval by the online system 140), the online system 140 transmits the orders to the picking user client device 110 associated with the picking user that accepted the orders. The picking user collects the ordered items from a store location and delivers the ordered items to the requesting user. The online system 140 may charge a requesting user for the order and provide portions of the payment from the requesting user to the picking user and the store.

As an example, the online system 140 may allow a requesting user to order groceries from a grocery store. The requesting user's order may specify which groceries they want delivered from the grocery store and the quantities of each of the groceries. The requesting user's client device 100 transmits the requesting user's order to the online system 140 and the online system 140 selects a picking user to travel to the grocery store location to collect the groceries ordered by the requesting user. Once the picking user has collected the groceries ordered by the requesting user, the picking user delivers the groceries to a location transmitted to the picking user client device 110 by the online system 140.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are language models configured to perform one or more NLP tasks. The NLP tasks include, but are not limited to, text generation, query processing, machine translation, chatbots, and the like. In one or more embodiments, a language model of the model serving system 150 is configured as a transformer neural network architecture (i.e., a transformer model). Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. The language model can be configured as any other appropriate architecture including, but not limited to, transformer-based networks, long short-term memory (LSTM) networks, Markov networks, BART, generative-adversarial networks (GAN), diffusion models (e.g., Diffusion-LM), and the like.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one order fulfillment instance, the context in the prompt includes portions of the structured indices as contextual information for the query. The interface system 160 obtains one or more responses from the model serving system 150 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

The smart cart 170 is a cart (e.g., a shopping cart) with one or more sensors and a computing device. The one or more sensors may detect various information relating to the smart cart 170. The sensors may include cameras and/or load sensors coupled to the baskets of the smart cart 170. The cameras can capture image data of items obtained. The load sensors can capture load data indicating a load on each basket. Further example sensors include a scanner for scanning items that are placed into the smart cart 170, a location sensor for tracking a position of the smart cart 170 in the in-store environment, etc. The computing device of the smart cart 170 processes the data captured by the sensors and, optionally, other data provided from other components of the system environment, e.g., the requesting user client device 100, the picking user client device 110, the store computing system 120, the online system 140, etc. The computing device can provide content to the user of the smart cart 170 during their store visit. The content may be generated by the smart cart 170 and/or other components of the system environment.

In some examples, a requesting user can use the smart cart 170. In such examples, the smart cart 170 may access a profile on the requesting user, e.g., to retrieve relevant user preference data. The requesting user could also provide a list, such that the smart cart 170 can assist the requesting user in filling the list, e.g., like an order. The smart cart 170 may also present a graphical user interface on an electronic display of the smart cart 170. The user may interact with the graphical user interface, e.g., to query to view items, to add items to an item list, etc.

In other examples, a picking user can user the smart cart 170 to fulfill orders by requesting users of the online system 140. In such examples, the smart cart 170 can perform functionality of the picking user client device 110. The smart cart 170 may also generate and provide fulfillment instructions to assist the picking user in fulfilling the batch of orders.

FIG. 1B illustrates an example system environment for an online system 140, in accordance with one or more embodiments. The system environment illustrated in FIG. 1B includes a requesting user client device 100, a picking user client device 110, a store computing system 120, a network 130, an online system 140, and a smart cart 170. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

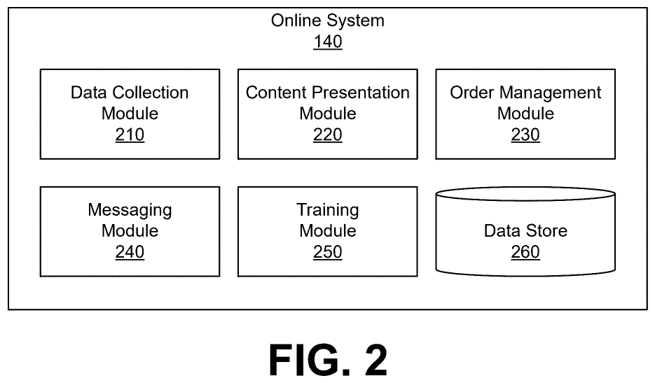

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140. The online system 140 is described in further detail below with regards to FIG. 2.

### Online System Architecture

FIG. 2 illustrates an example system architecture for an online system 140, in accordance with some embodiments. The system architecture illustrated in FIG. 2 includes a data collection module 210, a content presentation module 220, an order management module 230, a messaging module 240, a training module 250, and a data store 260. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 210 collects data used by the online system 140 and stores the data in the data store 260. The data collection module 210 may only collect data describing a user if the user has previously explicitly consented to the online system 140 collecting data describing the user. Additionally, the data collection module 210 may encrypt all data, including sensitive or personal data, describing users.

For example, the data collection module 210 collects requesting user data, which is information or data that describe characteristics of a requesting user. For example, the data collection module 210 may collect a requesting user's name, address, other demographic information (e.g., age range, family size, dietary restrictions or preferences, etc.), preferences (e.g., store visit frequency, order magnitude, etc.), previous orders, favorite items, favorite types of items, favorite stores, favorite picking users, repeat picking users, stored payment instruments, health sensor data, fitness objectives, or some combination thereof. The requesting user data also may include default settings established by the requesting user, such as a default store/store location, payment instrument, delivery location, or delivery timeframe. The requesting user data may also include user preference data indicating one or more preferences, e.g., provided by the user and/or inferred by the online system 140. The data collection module 210 may collect the requesting user data from sensors on the requesting user client device 100 or based on the requesting user's interactions with the online system 140.

The data collection module 210 also collects item data, which is information or data that identifies and describes items that are available at a store location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the dependability of items in store locations, also referred to as “dependability.” For example, for each item-store combination (a particular item at a particular warehouse), the item data may include a time that the item was last found, a time that the item was last not found (a picking user looked for the item but could not find it), the rate at which the item is found, or the popularity of the item. The data collection module 210 may collect item data from a store computing system 120, a picking user client device 110, or the requesting user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 210 also collects picking user data, which is information or data that describes characteristics of picking users. For example, the data collection module 210 may collect the picking user's name, the picking user's location, how often the picking user has serviced orders for the online system 140, a requesting user rating for the picking user, a number of requesting users that have favorited the picking user, which stores the picking user has collected items at, or the picking user's previous shopping history. The data collection module 210 may also collect information describing the manner in which the picking user completes orders. For example, the information may describe one or more route(s) taken to and/or from the store location(s), one or more route(s) taken within the in-store environment, a conversation between the supposed picking user and a requesting user corresponding to the order(s), other metrics relating to completion of the order, etc. Additionally, the picking user data may include preferences expressed by the picking user, such as their preferred stores to collect items at, how far they are willing to travel to deliver items to a requesting user, how many items they are willing to collect at a time, timeframes within which the picking user is willing to service orders, payment information by which the picking user is to be paid for servicing orders (e.g., a bank account), feedback from the picking user in fulfilling requesting user orders, etc. The data collection module 210 collects picking user data from sensors of the picking user client device 110 or from the picking user's interactions with the online system 140.

Additionally, the data collection module 210 collects order data, which is information or data that describes characteristics of an order. For example, order data may include item data for items that are included in the order, a delivery location for the order, a requesting user associated with the order, a store location from which the requesting user wants the ordered items collected, or a timeframe within which the requesting user wants the order delivered. Order data may further include information describing how the order was serviced, such as which picking user serviced the order, when the order was delivered, or a rating that the requesting user gave the delivery of the order. In some embodiments, the order data includes user data for users associated with the order, such as requesting user data for a requesting user who placed the order or picking user data for a picking user who serviced the order.

The content presentation module 220 selects content for presentation to a user. For example, the content presentation module 220 selects which items to present to a requesting user while the requesting user is placing an order and/or using a smart cart during an in-store visit. In embodiments with the requesting user placing an order, the content presentation module 220 generates and transmits an ordering interface for the requesting user to order items. The content presentation module 220 populates the ordering interface with items that the requesting user may select for adding to their order. In some embodiments, the content presentation module 220 presents a catalog of all items that are available to the requesting user, which the requesting user can browse to select items to order. The content presentation module 220 also may identify items that the requesting user is most likely to order and present those items to the requesting user. For example, the content presentation module 220 may score items and rank the items based on their scores. The content presentation module 220 displays the items with scores that exceed some threshold (e.g., the top n items or the p percentile of items).

In embodiments with the requesting user using a smart cart during an in-store visit, the content presentation module 220 may generate and transmit a cart interface for presentation on the smart cart 170. In other embodiments, the smart cart 170 may generate the cart interface. The cart interface may provide details about the user and/or the in-store visit, a list of one or more items in the smart cart, one or more item recommendations, or some combination thereof. The content presentation module 220 may implement a recommendation model for determining one or more item recommendations for presentation in the cart interface. The content presentation module 220 may train the recommendation model as a machine-learning model, and, optionally, as a multimodal model. In one or more embodiments, the recommendation model may input a list of items in a smart cart 170, a location of the smart cart 170 in the in-store environment, items in the item database, other contextual data, or some combination thereof.

The content presentation module 220 may use a scoring function to score items for presentation to a requesting user. The scoring function may score items for a requesting user based on item data for the items and requesting user data for the requesting user. The scoring function may determine a ranking score based on ranking parameter values for each item and a weight vector. In some embodiments, an item selection model trained as a machine-learning model may determine a likelihood that the requesting user will order the item. In some embodiments, the item selection model uses item embeddings describing items and requesting user embeddings describing requesting users to score items. These item embeddings and requesting user embeddings may be generated by separate machine-learning models and may be stored in the data store 260.

The order management module 230 manages orders by requesting users. The order management module 230 receives orders from one or more requesting user client devices 100. The order management module 230 may batch orders together based on characteristics of the orders. For example, the order management module 230 may batch orders to be fulfilled at the same store location with similar completion time windows. The order management module 230 may present available orders (or batches of orders) to one or more picking users via their picking user client devices 110. The picking users may select orders presented by the order management module 230. For example, the order management module 230 may provide optionality to a picking user to select a particular order based on the picking user's location and the location of the store from which the ordered items are to be collected.

In some embodiments, the order management module 230 implements a matching module to determine actions to take in facilitating a match of a batch of orders to a picking user. The matching module may decide from the following actions: (1) increasing broadcast breadth of a batch, i.e., presenting the batch for selection or acceptance by more picking users, (2) increasing a boost signal for the batch, i.e., increasing incentives for acceptance of the batch, or (3) holding the broadcast signal and the boost signal constant. At a first timestep, the matching module determines which action to take based on a current state of the broadcast breadth and a current boost signal. The matching module may further evaluate a selection prediction output by a selection prediction model which is configured to predict the likelihood of batch acceptance by a picking user based on the current boost signal. After determining the action, the matching module performs the action, whether that includes presenting the batch to more picking users for the option to select the batch or updating presentation of the batch with an increased boost signal to picking users already presented with the batch. The matching module may iteratively determine and perform actions until the batch is selected by a picking user. The matching module may be trained as a machine-learning model with historical data relating to matching of orders (or batches of orders) to picking users. In one or more embodiments, the matching module may implement dynamic programming to determine the action to undertake in each timestep. The matching module may evaluate a cost function associated with each action at the current timestep to evaluate which action to take. The cost function may account for irreversibility of the actions, i.e., the boost signal for a batch can never be decreased, and the broadcast breadth of a batch can never be decreased, while optimizing for batch fulfillment efficiency and expenditure of system resources in boosting a batch.

In some embodiments, the order management module 230 determines when to transmit an order to a picking user based on a delivery timeframe requested by the requesting user with the order. The order management module 230 computes an estimated amount of time that it would take for a picking user to collect the items for an order and deliver the ordered items to the delivery location for the order. The order management module 230 transmits the order to a picking user at a time such that, if the picking user immediately fulfills the order, the picking user is likely to deliver the order at a time within the requested timeframe. Thus, when the order management module 230 receives an order, the order management module 230 may delay in transmitting the order to a picking user if the requested timeframe is far enough in the future (i.e., the order management module 230 provides, at a later time, the optionality to the picking user to select an order, such that there is sufficient predicted time to meet the requested timeframe).

The order management module 230 transmits the order to an account associated with the picking user (or a client device accessing the account), e.g., with the content presentation module 220. The order management module 230 may also transmit navigation instructions from the picking user's current location to the store location associated with the order. If the order includes items to collect from multiple store locations, the order management module 230 identifies the store locations to the picking user and may also specify a sequence in which the picking user should visit the store locations.

The order management module 230 may track the location of the picking user through the picking user client device 110 to determine when the picking user arrives at the store location. When the picking user arrives at the store location, the order management module 230 transmits the order to the picking user client device 110 for display to the picking user. As the picking user uses the picking user client device 110 to collect items at the store location, the order management module 230 receives item identifiers for items that the picking user has collected for the order. In some embodiments, the order management module 230 receives images of items from the picking user client device 110 and applies computer-vision techniques to the images to identify the items depicted by the images. The order management module 230 may track the progress of the picking user as the picking user collects items for an order and may transmit progress updates to the requesting user client device 100 that describe which items have been collected for the requesting user's order.

The order management module 230 determines when the picking user has collected all of the items for an order. For example, the order management module 230 may receive a message from the picking user client device 110 indicating that all of the items for an order have been collected. Alternatively, the order management module 230 may receive item identifiers for items collected by the picking user and determine when all of the items in an order have been collected. When the order management module 230 determines that the picking user has completed an order, the order management module 230 transmits the delivery location for the order to the picking user client device 110. The order management module 230 may also transmit navigation instructions to the picking user client device 110 that specify how to travel from the store location to the delivery location, or to a subsequent store location for further item collection. The order management module 230 tracks the location of the picking user as the picking user travels to the delivery location for an order, and updates the requesting user with the location of the picking user so that the requesting user can track the progress of the order. In some embodiments, the order management module 230 computes an estimated time of arrival of the picking user at the delivery location and provides the estimated time of arrival to the requesting user.

The order management module 230 coordinates payment by the requesting user for the order. The order management module 230 uses payment information provided by the requesting user (e.g., a credit card number or a bank account) to receive payment for the order. In some embodiments, the order management module 230 stores the payment information for use in subsequent orders by the requesting user. The order management module 230 computes a total cost for the order and charges the requesting user that cost. The order management module 230 may provide a portion of the total cost to the picking user for servicing the order, and another portion of the total cost to the store. The order management module 230 may further provide an option to the requesting user to provide a tip to the picking user, e.g., for outstanding service.

The messaging module 240 facilitates communication between the requesting user client device 100 and the picking user client device 110. As noted above, a requesting user may use a requesting user client device 100 to send a message to the picking user client device 110. The messaging module 240 receives the message from the requesting user client device 100 and transmits the message to the picking user client device 110 for presentation to the picking user. The picking user may use the picking user client device 110 to send a message to the requesting user client device 100 in a similar manner. Communications between the requesting user and the picking user may be provided to the content presentation module 220.

The training module 250 trains machine-learning models used by the online system 140. For example, the training module 250 may train the item selection model, the query processing models, the featurization model, the language models, the selection prediction model, the decision model, or any of the machine-learned models deployed by the model serving system 150. The online system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The training module 250 generates the set of parameters (e.g., the particular values of the parameters) for a machine-learning model by “training” the machine-learning model. Once trained, the machine-learning model uses the set of parameters to transform inputs into outputs.

The training module 250 trains a machine-learning model based on a set of training examples. Each training example includes input data to which the machine-learning model is applied to generate an output. For example, each training example may include requesting user data, picking user data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The training module 250 may apply an iterative process to train a machine-learning model whereby the training module 250 updates parameter values of the machine-learning model based on each of the set of training examples. The training examples may be processed together, individually, or in batches. To train a machine-learning model based on a training example, the training module 250 applies the machine-learning model to the input data in the training example to generate an output based on a current set of parameter values. The training module 250 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross-entropy loss function. The training module 250 updates the set of parameters for the machine-learning model based on the score generated by the loss function. For example, the training module 250 may apply gradient descent to update the set of parameters.

The training module 250 may further fine tune trained models based on empirical results. After deployment of a model, the data collection module 210 may collect data that can be used to evaluate the accuracy of the model's outputs and/or predictions. The data may include feedback or engagement by users. The training module 250 generates additional training examples from the empirical results for retraining or fine-tuning of the models.

The data store 260 stores data used by the online system 140. For example, the data store 260 stores requesting user data, store data, item data, order data, and picking user data for use by the online system 140. The data store 260 also stores trained machine-learning models trained by the training module 250. For example, the data store 260 may store the set of parameters for a trained machine-learning model on one or more non-transitory, computer-readable media. The data store 260 uses computer-readable media to store data, and may use databases to organize the stored data.

With respect to the machine-learned models hosted by the model serving system 150, the machine-learned models may already be trained by a separate entity from the entity responsible for the online system 140. In one or more other embodiments, when the model serving system 150 is included in the online system 140, the training module 250 may further train parameters of the machine-learned model based on data specific to the online system 140 stored in the data store 260. As an example, the training module 250 may obtain a pre-trained transformer language model and further fine-tune the parameters of the transformer model using training data stored in the data store 260. The training module 250 may provide the model to the model serving system 150 for deployment.

### Batch Matching Via Synchronization of Broadcast and Boosting

FIG. 3 is an illustrative flowchart describing batch matching by synchronization of broadcast and boosting, in accordance with one or more embodiments. Broadcast refers to notifying pickers of a batch that is available for selection. Boosting refers to adding a boost signal when notifying pickers of an available batch. Increasing broadcast or boost generally effectuates quickened selection of the batch; however, synchronization of the two dials mitigates uncoordinated control of the two levers, thereby leading to wasted resources. The description of FIG. 3 is in the perspective of the order management module 230 of the online system 140. In other embodiments, one or more of the steps described may be performed by other modules or systems, e.g., in the system environment.

The order management module 230 receives order data 310 from requesting user client devices 100. The order data 310 may specify store locations from which to obtain one or more items. The order data 310 may further specify other fulfillment criteria, e.g., delivery address, delivery timeframe, etc. A batching module 320 of the order management module 230 may batch orders together into a batch 325. Batching orders generally improves fulfillment efficiency in that the orders are better distributed across pickers for fulfillment. For example, instead of sending two orders to be fulfilled at one store location (with otherwise very similar fulfillment criteria) to two different pickers, the two orders may be batched together and sent to one picker, thereby freeing up the other picker to fulfill other orders (or batches). In crafting batches, the batching module 320 may be configured as a machine-learning model to optimize batching for improved fulfillment efficiency. Batching is further described in U.S. application Ser. No. 17/018,096 (now U.S. Pat. No. 11,580,860) filed on Sep. 11, 2020, and U.S. application Ser. No. 17/935,091 filed on Sep. 24, 2022, both of which are incorporated by reference in its entirety.

A broadcast module 330 of the order management module 230 seeks to identify candidate pickers 335 to notify of the batch 325 for selection by one of the pickers. The matching model 340 inputs pickers data 315, which provides information on the current candidate pickers that could select and fulfill orders. The information may indicate current order load of each candidate picker, fulfillment statistics on each candidate picker, location or current progress in fulfillment of one or more selected orders by each candidate picker, etc. The broadcast module 330 may further input a prior boost 352, which is an added incentive in boosting the signal of the batch 325 when presenting to pickers. On an initial timestep of broadcast of the batch 325, the prior boost 352 may be zero, i.e., there was no prior boost 352.

At subsequent timesteps, when seeking to increase the broadcast signal, the broadcast module 330 may increase the broadcast signal by expanding various metrics. For example, at the initial timestep, the broadcast module 330 may identify all candidate pickers satisfying the one or more metrics (e.g., order load below certain threshold, physical location within a threshold radius to the one or more fulfillment locations, fulfillment efficiency of the picker above a threshold, selection prediction of the picker above a threshold, etc.). At the subsequent timesteps, the broadcast module 330 may expand these various metrics to achieve a target expansion in the broadcast signal, e.g., by increasing the order load threshold, increasing the threshold radius, lowering the fulfillment efficiency threshold, lowering the selection prediction threshold, etc.

In one or more embodiments, the broadcast module 330 may also leverage a selection prediction 375 output by a selection prediction model 370. The selection prediction model 370 is configured to input information on a batch 325 (or order) and picker data 315 to output the selection prediction 375 indicating a likelihood that a picker would accept the batch 325. In some embodiments, the selection prediction model 370 may be configured to output an individual selection prediction 375 per picker. The selection prediction model 370 may be trained on historical sessions by the picker. In one or more embodiments, the selection prediction model 370 may be a parametrized model that inputs one or more parameters of orders fulfilled by the picker to output a selection prediction 375 based on the picker's historical sessions. For example, the selection prediction model 370 may be parameterized by (optionally, among other parameters) the boost signal of orders that the picker was notified of.

A boosting module 350 determines a current boost 355 to incentivize pickers to selection of the batch 325. The boosting module 350 may determine the current boost 355 based on the prior boost 352 and, optionally, based on the selection prediction 375. In some embodiments, the boosting module 350 may leverage a machine-learning model to determine the current boost 355. A larger current boost 355 may quicken selection of the batch 325 by a picker, but at the cost of finite resources for allocation by the online system 140. In one or more embodiments, the boosting module 350 may perform stepwise boosting, e.g., each step size between a prior boost and a current boost is fixed. In other embodiments, the boost step size may be dynamic. In one or more embodiments, the boost signal has a maximum.

A matching module 340 facilitates matching of the batch to a picker for fulfillment. The matching module 340 may undertake actions to facilitate the matching process. At each timestep (following batch creation), the matching module 340 identifies an action to undertake in the matching process, i.e., increasing broadcast, increasing boost, or holding. The timesteps may be discrete steps occurring at a certain frequency, e.g., every minute, every 5 minutes, etc. The matching module 340 may leverage a decision model configured to input information of the batch, information on the candidate pickers 335, and the current boost 355 to output which action to undertake, to increase the broadcast signal or to increase the boost signal. In some embodiments, the decision model may be further configured to input past catalyst actions taken in conjunction with the batch 325. Increasing the broadcast signal entails notifying additional pickers (e.g., via their picking user client devices 110) of the batch 325, thereby providing those additional pickers with the option to select the batch 325 for fulfillment. Increasing the boost signal entails notifying the current set of candidate pickers notified of the batch that there is an increase in the boost (i.e., incentive) of the batch. In one or more embodiments, both increasing the broadcast signal and increasing the boost signal are irreversible actions. As such, once candidate pickers are notified of the batch, the batch cannot be rescinded until selected by another picker and thus made unavailable to others. Also, once the candidate pickers are notified of the increased boost signal, the boost cannot be lowered.

In one or more embodiments, the decision model of the matching module 340 may be a machine-learning model trained on historical session data inclusive of past sessions where the order management module 230 has facilitated matching of batches and pickers. In one or more embodiments, the machine-learning model may be trained to achieve various matching parameters (i.e., time-to-selection by a candidate picker, eventual fulfillment efficiency by the selector picker, distributed system resources from the boost signal, etc.). Each action is a stochastic process without any guaranteed results. As such, either action has some unknown likelihood of achieving selection by a candidate picker that is notified of the batch. Moreover, at each timestep until selection by a candidate picker, the machine-learning model is tasked with identifying and enacting an action to facilitate matching. Interestingly, actions can have downstream effects, e.g., once the boost signal is increased, the desirability of the batch and consequently the likelihood of selection will rise and generally won't decline. In general, the matching module 340 may seek to minimize time-to-selection, to maximize fulfillment efficiency, to minimize distribution of system resources, or some combination thereof. In training, each matching parameter may have a disparate weighting, i.e., to prioritize the various matching parameters. The goal of the model is to maximize achieving the disparately weighted matching parameters, e.g., maximizing an objective function that is a weighted sum of the various matching parameters.

After performing an action, i.e., whether increasing the broadcast signal or increasing the boost signal to picker client devices 110, the matching module 340 evaluates engagement with the batch. For example, the matching module 340 may track picker viewing statistics. If the candidate pickers have yet to view the batch (e.g., due to being preoccupied with fulfillment of other orders), then the matching module 340 may wait to take further action. If, however, the candidate pickers presently notified of the batch (with any the current boost 355) have viewed the batch but have yet to select the batch, then the matching module 340 may determine an action to take, i.e., whether to increase the broadcast signal or to increase the boost signal. In increasing the broadcast signal, the matching module 340 may query the broadcast module 330 to provide an additional set of candidate pickers 335 to broadcast to. With the additional set of candidate pickers 335, the matching module 340 may transmit the batch (with any current boost 355) to the additional set of candidate pickers 335 (e.g., via their picking user client device 110). In increasing the boost signal, the matching module 340 may query the boosting module 350 to provide an increased current boost 355. The matching module 340 may update the notification of the current set of candidate pickers 335 with the increased current boost 355. This synchronization of the two levers, broadcast and boost, with a central decision-making module provides for a technical solution to the technical problem of independently leveraging the two levers, creating the systemic inefficiencies.

In one or more example implementations, at a first timestep, the matching module 340 may start with broadcast the batch 325 to a small set of candidate pickers 335 (output by the broadcast module 330). If there is no match after a period of time, i.e., none of the candidate pickers selects the batch 325, then the matching module 340, at the second timestep (after the first timestep), identifies and performs an action to catalyze the matching. In some embodiments, the matching module 340 performs either an increase of the broadcast signal or an increase of the boost signal. In other embodiments, the matching module 340 may perform both increase of the broadcast signal and increase of the boost signal (to varying degrees). After another period of time elapses after performing the action, if there is yet no match, then the matching module 340 identifies and performs another action to further catalyze the matching.

The matching module 340 may iteratively identify and perform an action, wait for a period of time for matching to occur, while assessing whether any match has occurred (i.e., whether a candidate picker notified of the batch 325 has selected the batch 325 for fulfillment).

In one or more embodiments, the matching module 340 may facilitate matching of a plurality of batches. In such embodiments, the matching module 340 may be configured to further identify which batches to catalyze at any given timestep. In some embodiments, the matching module 340 may leverage the machine-learning model to identify which actions to perform on which batches. For example, the matching module 340 may increase broadcast on a first set of batches, increase boost on a second set of batches, hold broadcast and boost on a third set of batches, or some combination thereof. The machine-learning model may be trained based on the historical sessions to further identify which combination of actions is best. Without such coordination across the batches, actions to one batch affect the desirability of other batches, e.g., boosting of one batch creates innate incentive disparities against the other non-boosted batches. This yields a further technical improvement in that the coordination across the batches takes into account matching of all batches and not solely singular ones.

In one or more embodiments, the matching module 340 generates a graphical user interface for presenting the batch and the boost for presentation to the candidate pickers 335.

The graphical user interface may present all available batches and/or orders received by the order management module 230. The graphical user interface, when presented by the picking user client device 110, may list the various batches and/or orders with the boost. In one or more embodiments, the matching module 340 transmits data of the batch (e.g., summary of orders in the batch, delivery details, any current boost, etc.) to picker client devices; the data then presented in a graphical user interface on the picking user client device 110. The graphical user interface may provide a real-time indication of the boost signal. In other embodiments, the matching module 340 may also modify a display order of the current available batches and/or orders. For example, the matching module 340 may present batches and/or orders with higher boost in a priority manner (e.g., in the center of the interface, at the top of the available order/batch list, etc.). In its one or more queries, the matching module 340 may indicate an increased amount for the broadcast signal and/or the boost signal. For example, the matching module 340 may indicate to increase the broadcast signal to reach twice as many candidate pickers.

### Example Methods

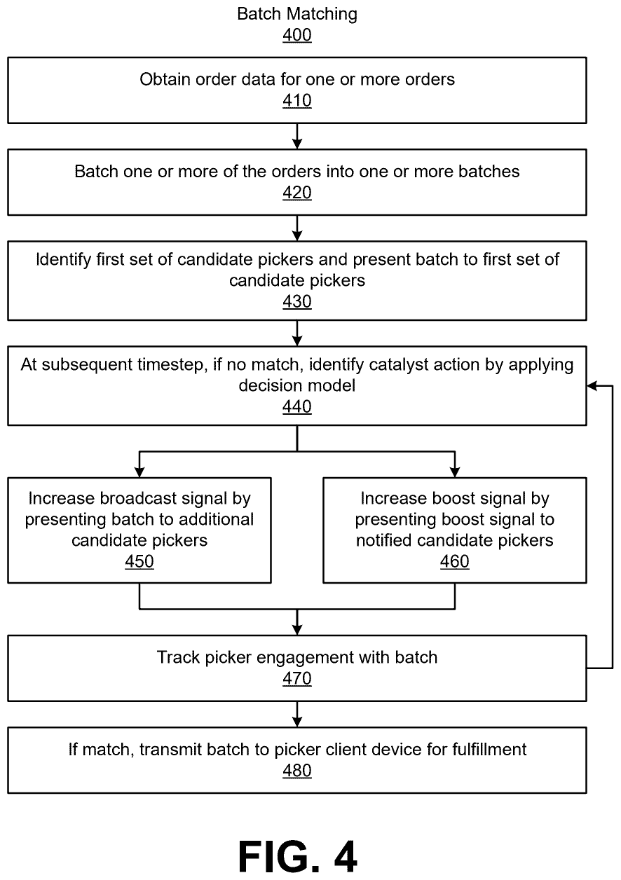

FIG. 4 is a method flowchart describing the process of batch matching 400 by synchronization of broadcast and boosting, in accordance with one or more embodiments. The batch matching 400 method is described as being performed by an online system (e.g., the online system 140). In other embodiments, other entities may perform some or all of the steps (e.g., in conjunction with the online system). In other embodiments, the batch matching 400 method may include additional, fewer, or different steps than those listed herein.

The online system obtains 410 order data for one or more orders. The orders may be transmitted from customer client devices. Each order may indicate one or more items to obtain from one or more fulfillment locations (e.g., retail stores). The order may further indicate other fulfillment criteria indicating the manner in which to fulfill the order, e.g., delivery address, delivery timeframe, delivery instructions, etc.

The online system batches 420 the one or more orders into one or more batches. The online system may batch orders together by identifying common characteristics across batches. For example, the online system may batch orders to be fulfilled at the same fulfillment location together. As another example, the online system may batch orders with similar items.

The online system may obtain information on the pickers available for selecting and fulfilling orders. The information may include a (approximate) physical location of the picker, current order load of the picker, current status or progress in completion of in-progress orders, availability schedule, etc.

The online system (for each batch) identifies 430 a first set of candidate pickers and presents the batch to the first set of candidate pickers. The online system may identify the first set of candidate pickers based on the information on the available pickers. For example, the online system may seek to initially notify pickers located proximate to the one or more fulfillment locations associated with the batch of orders. The online system may use other criteria to identify the initial set to notify, e.g., based on other characteristics of the available pickers. The online system may leverage a selection prediction model to predict a likelihood that a candidate picker will select the batch based on the batch information and candidate picker's information.

Presenting the batch may include generating and transmitting a user interface for presenting information on the batch to client devices associated with the candidate pickers.

Presenting the batch may include transmitting information on the batch to client devices for presentation in the user interface.

Once the candidate pickers are notified, the online system evaluates whether a candidate picker has matched with (i.e., selected) the batch. If the candidate picker has matched with the batch, then the online system may transmit 480 the batch (e.g., with full details) to the picker's client device for fulfillment.

If at a subsequent timestep, there is no match, the online system identifies 440 a catalyst action by applying a decision model. Catalyst actions may include increasing the broadcast signal or increasing the boost signal for the batch. The broadcast signal controls how widespread a batch is broadcast to candidate pickers. The boost signal controls a size of an incentive to select the batch. The decision model may be a machine-learning model trained to identify which catalyst action to undertake to achieve for matching parameters (e.g., time-to-selection, fulfillment efficiency, lag time, distribution of system resources, etc.). The decision model may further take into account past catalyst actions taken for a batch, likelihoods of candidate pickers selecting the batch conditioned on the catalyst action being taken, picker engagement with the batch, information on batches in aggregate, etc.

In increasing the broadcast signal, the online system presents 450 the batch to additional candidate pickers. The online system may identify 450 the additional candidate pickers by expanding various thresholds (e.g., expanding a threshold distance radius, lowering the fulfillment efficiency, etc.). In some embodiments, each increase step may be set to notify a target expansion in candidate pickers.

In increasing the boost signal, the online system presents 460 the boost signal to candidate pickers already notified of the batch. The online system may determine the increase in the boost signal. In some embodiments, each step is fixed. In other embodiments, the step may be dynamically set. In some embodiments, there is a max boosting signal, such that the decision model takes into account progression towards the max.

The online system tracks 470 picker engagement with the batch. If a candidate picker has selected the batch, the online system can transmit 480 the batch (e.g., the full details) over the picker's client device for fulfillment. If no picker has yet selected the batch (i.e., no match), then the online system can iterate through identifying and performing catalyst actions via the decision model, thereby synchronizing the use of the broadcast signal and the boost signal toggles. The engagement with the batch may further be leveraged in training the various models, e.g., the selection prediction model and/or the decision model.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor may comprise one or more sub-processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed by a computer system comprising a processor and a non-transitory computer-readable medium, comprising:
batching one or more orders, received by an online system from client devices associated with a plurality of requesting users, into a batch of orders;
at a first timestep, causing presentation of a user interface displaying the batch of orders on the client devices associated with a first set of candidate picking users;
responsive to a lack of selection of the batch of orders during a first time period following the first timestep, at a second timestep following the first time period:
accessing a plurality of catalyst actions, wherein the plurality of catalyst actions comprise: increasing a broadcast signal controlling presentation to candidate picking users and increasing a boost signal controlling an incentive to selection of the batch;
identifying which of the plurality of catalyst actions to perform by applying a decision model to information about the batch of orders, information about the candidate picking users, and information describing the plurality of catalyst actions, wherein the decision model is a machine learning model trained on historical selections by picking users of historical batches of orders to achieve one or more matching parameters,
responsive to identifying the catalyst action of increasing the broadcast signal:
identifying a second set of candidate picking users to broadcast the batch of orders based on the information describing the plurality of candidate picking users, and
causing presentation of the user interface displaying the batch of orders on the client devices associated with the second set of candidate picking users, and
responsive to identifying the catalyst action of increasing the boost signal:
causing presentation of the boost signal in the user interface presented on the client devices associated with the first set of candidate picking users; and
receiving, via the user interface presented on a client device associated with a candidate picking user of the first or second sets of candidate picking users, a selection of the batch of orders by the candidate picking user.

2. The method of claim 1, wherein batching of the one or more orders comprises:
identifying characteristics of each order received by the online system; and
grouping the one or more orders together to form the batch of orders based on common characteristics among the orders in the batch of orders.

3. The method of claim 1, further comprising:
at the first timestep, identifying the first set of candidate picking users to broadcast the batch of orders based on information describing a plurality of candidate picking users associated with client devices connected to the online system.

4. The method of claim 3, wherein identifying the first set of candidate picking users to broadcast the batch of orders comprises:
applying, for each candidate picking user, a selection prediction model to information on the batch of orders and the information representing the candidate picking user to output a prediction on a likelihood of the candidate picking user selecting the batch of orders; and
identifying the first set of candidate picking users based on the predictions.

5. The method of claim 4, wherein the selection prediction model is a machine-learning model parameterized based on one or more historical selections by the candidate picking user of one or more historical batches of orders.

6. The method of claim 4, wherein applying, for each candidate picking user, the selection prediction model comprises applying the selection prediction model further on information describing the boost signal to output the prediction on the likelihood of the candidate picking user selecting the batch of orders.

7. The method of claim 4, wherein applying the decision model comprises applying the decision model further to the predictions output by the selection prediction model to output the catalyst action to perform.

8. The method of claim 1, further comprising:
tracking engagement by the first set of candidate picking users during presentation of the batch of orders during the first time period;
wherein applying the decision model comprises applying the decision model to information describing the tracked engagement.

9. The method of claim 8, further comprising:
generating a training example with the tracked engagement and the identified catalyst action; and
retraining the decision model using the training example.

10. The method of claim 1, further comprising:
responsive to a continued lack of selection of the batch of orders during a second time period, at a third timestep following the second time period:
identifying a next catalyst action to perform by applying the decision model to the catalyst action previously performed to output the next catalyst action to perform.

11. The method of claim 1, further comprising:
batching one or more additional order received by the online system into a second batch of orders;
wherein applying the decision model to output the catalyst action to perform for the batch of orders comprises applying the decision model further to information on the second batch of orders.

12. A non-transitory computer-readable storage medium storing instructions that, when executed by a processor, cause the processor to perform operations comprising:
batching one or more orders, received by an online system from client devices associated with a plurality of requesting users, into a batch of orders;
at a first timestep, causing presentation of a user interface displaying the batch of orders on the client devices associated with a first set of candidate picking users;
responsive to a lack of selection of the batch of orders during a first time period following the first timestep, at a second timestep following the first time period:
accessing a plurality of catalyst actions, wherein the plurality of catalyst actions comprise: increasing a broadcast signal controlling presentation to candidate picking users and increasing a boost signal controlling an incentive to selection of the batch;
identifying which of the plurality of catalyst actions to perform by applying a decision model to information about the batch of orders, information about the candidate picking users, and information describing the plurality of catalyst actions, wherein the decision model is a machine learning model trained on historical selections by picking users of historical batches of orders to achieve one or more matching parameters,
responsive to identifying the catalyst action of increasing the broadcast signal:
identifying a second set of candidate picking users to broadcast the batch of orders based on the information describing the plurality of candidate picking users, and
causing presentation of the user interface displaying the batch of orders on the client devices associated with the second set of candidate picking users, and
responsive to identifying the catalyst action of increasing the boost signal:
causing presentation of the boost signal in the user interface presented on the client devices associated with the first set of candidate picking users; and
receiving, via the user interface presented on a client device associated with a candidate picking user of the first or second sets of candidate picking users, a selection of the batch of orders by the candidate picking user.

13. The non-transitory computer-readable storage medium of claim 12, wherein batching of the one or more orders comprises:
identifying characteristics of each order received by the online system; and
grouping the one or more orders together to form the batch of orders based on common characteristics among the orders in the batch of orders.

14. The non-transitory computer-readable storage medium of claim 12, the operations further comprising:
at the first timestep, identifying the first set of candidate picking users to broadcast the batch of orders by:
applying, for each candidate picking user, a selection prediction model to information on the batch of orders and information representing the candidate picking user to output a prediction on a likelihood of the candidate picking user selecting the batch of orders; and
identifying the first set of candidate picking users based on the predictions.

15. The non-transitory computer-readable storage medium of claim 14, wherein the selection prediction model is a machine-learning model parameterized based on one or more historical selections by the candidate picking user of one or more historical batches of orders.

16. The non-transitory computer-readable storage medium of claim 14, wherein applying, for each candidate picking user, the selection prediction model comprises applying the selection prediction model further on information describing the boost signal to output the prediction on the likelihood of the candidate picking user selecting the batch of orders.

17. The non-transitory computer-readable storage medium of claim 12, the operations further comprising:
tracking engagement by the first set of candidate picking users during presentation of the batch of orders during the first time period,
wherein applying the decision model comprises applying the decision model to information describing the tracked engagement.

18. The non-transitory computer-readable storage medium of claim 12, the operations further comprising:
responsive to a continued lack of selection of the batch of orders during a second time period, at a third timestep following the second time period:
identifying a next catalyst action to perform by applying the decision model to the catalyst action previously performed to output the next catalyst action to perform.

19. The non-transitory computer-readable storage medium of claim 12, the operations further comprising:
batching one or more additional order received by the online system into a second batch of orders;
wherein applying the decision model to output the catalyst action to perform for the batch of orders comprises applying the decision model further to information on the second batch of orders.

20. A system comprising:
a processor; and
a non-transitory computer-readable storage medium storing instructions that, when executed by the processor, cause the processor to perform operations comprising:
batching one or more orders, received by the system from client devices associated with a plurality of requesting users, into a batch of orders;
at a first timestep, causing presentation of a user interface displaying the batch of orders on the client devices associated with a first set of candidate picking users;
responsive to a lack of selection of the batch of orders during a first time period following the first timestep, at a second timestep following the first time period:
accessing a plurality of catalyst actions, wherein the plurality of catalyst actions comprise: increasing a broadcast signal controlling presentation to candidate picking users and increasing a boost signal controlling an incentive to selection of the batch;
identifying which of the plurality of catalyst actions to perform by applying a decision model to information about the batch of orders, information about the candidate picking users, and information describing the plurality of catalyst actions, wherein the decision model is a machine learning model trained on historical selections by picking users of historical batches of orders to achieve one or more matching parameters,
responsive to identifying the catalyst action of increasing the broadcast signal:
identifying a second set of candidate picking users to broadcast the batch of orders based on the information describing the plurality of candidate picking users, and
causing presentation of the user interface displaying the batch of orders on the client devices associated with the second set of candidate picking users, and
responsive to identifying the catalyst action of increasing the boost signal:
causing presentation of the boost signal in the user interface presented on the client devices associated with the first set of candidate picking users; and
receiving, via the user interface presented on a client device associated with a candidate picking user of the first or second sets of candidate picking users, a selection of the batch of orders by the candidate picking user.
